(19) United States
(12) Patent Application Publication
(10) Pub. No.: US 2011/0302008 A1
(43) Pub. Date: Dec. 8, 2011

(54) Assessing engagement and influence using consumer-specific promotions in social networks

(76) Inventors: Harry R. Soza, San Jose, CA (US); Mark Wayman, Oakland, CA (US); Keith Rose, Alamo, CA (US); Jeffrey A. Roberts, Hayward, CA (US)

(21) Appl. No.: 13/136,548

(22) Filed: Aug. 4, 2011

Related U.S. Application Data
(63) Continuation of application No. 12/928,329, filed on Dec. 9, 2010, now abandoned.
Application No. 12/928,329 is a continuation-in-part of application No. 12/288,614, filed on Oct. 21, 2008.
Application No. 12/288,614 is a continuation-in-part of application No. 12/460,223, filed on Jul. 14, 2009.
Application No. 12/460,223 is a continuation-in-part of application No. 12/804,248, filed on Jul. 16, 2010.
(60) Provisional application No. 61/283,862, filed on Dec. 10, 2009.

(51) Int. Cl. G06Q 30/00

(52) U.S. Cl. 705/14.13

(57) ABSTRACT

A system and method for assessing engagement activities and influence using consumer-specific promotions in a social network environment is provided.

### CROSS-REFERENCE TO RELATED APPLICATIONS

This application is a continuation of U.S. patent application Ser. No. 12/928,329 filed Dec. 9, 2010, which is incorporated herein by reference in its entirity.

U.S. patent application Ser. No. 12/928,329 filed Dec. 9, 2010 claims priority from U.S. Provisional Patent Application 61/283,862 filed Dec. 10, 2009, which is incorporated herein by reference in its entirity. U.S. application Ser. No. 12/928,329 filed Dec. 9, 2010 is further a continuation-in-part of U.S. patent application Ser. No. 12/288,614 filed Oct. 21, 2008, which is incorporated herein by reference in its entirity.

U.S. application Ser. No. 12/928,329 filed Dec. 9, 2010 is further a continuation-in-part of U.S. patent application Ser. No. 12/460,223 filed Jul. 14, 2009, which is incorporated herein by reference in its entirity.

U.S. application Ser. No. 12/928,329 filed Dec. 9, 2010 is further a continuation-in-part of U.S. patent application Ser. No. 12/804,248 filed Jul. 16, 2010, which is incorporated herein by reference in its entirity.

### FIELD OF THE INVENTION

The invention relates generally to online promotions in social network systems. More particularly, the invention relates to computer-based systems and methods of assessing engagement and influence using consumer-specific promotions in social network systems.

### BACKGROUND OF THE INVENTION

The core dynamics of a social network is the communication between individuals who regards each other as some type of friend or personal acquaintance. At times, this communication involves an electronic discussion about some form of business promotion, such as a sale, special event, new model etc. For the business sponsoring the promotion, this discussion is a highly valuable form of word-of-mouth marketing which is enabled and accelerated by Internet technology.

### SUMMARY AND DESCRIPTION OF THE INVENTION

By originating the electronic word-of-mouth discussion, for example by sending a message to a friend, each individual is making a selection about which of their friends would want to hear about the promotion. This selection is a type of highly effective targeting based on information and perceptions not readily available to any outsider. Further in telling a friend about a specific promotion there is an implied testimonial by the sender regarding the value and validity of the promotion. Accordingly, for the sponsoring business, the sending of information (also referred to as viral spread) is a form of extraordinary well-targeted marketing supported by a personal testimonial from a friend.

A promotion often includes different elements or versions. Typically it includes a main message that is accompanied by related content or opportunities for deeper brand engagements (e.g. vote for favorite style). This format enables a consumer who is interested in the promotion to undertake more or fewer actions correlated to their level of interest.

To maximize the effectiveness of a promotion, it is desirable to present a set of elements (i.e. a “version” of the promotion) that may more directly relate to the demographics and/or prior behavior of a consumer. For example, a woman in San Francisco may favorably respond to certain aspects of a promotion, while an older man in Dallas may respond favorably to different elements of the same promotion. Visitors who have already voted for a favorite may see other promotional content on subsequent visits. The business opportunity is to tailor the promotion to the viewer to increase relevance and impact, and thereby stimulate the viewer to take action and the pass on the promotion to their friends.

In a social network, each viewer is consistently identified, and has a profile of self-reported characteristics. This creates an environment where a highly tailored promotional presentation can be undertaken. It is also possible to track the historical promotional actions taken by each viewer, the extent of subsequent digital pass-along, and how effective the promotion is at creating the desired business outcomes (e.g. purchases, sign-ups, greater audience, etc.).

To understand the effectiveness of their consumer-specific tailored promotions a business sponsoring these promotions needs a technology system that can identify key demographic and prior-use characteristics of viewers and deliver that version of the promotion most closely aligned with that profile. The system is then capable of tracking and recording user engagements with all of the various activity elements, especially digital pass-along, to assess the effectiveness of the various versions and activity elements of the promotions.

Embodiments of the invention involve a computer implemented system capable of identifying, using data provided by a social network, specific business-related characteristics of those individuals who view an on-line promotion.

Embodiments of the invention further involve a computer implemented system capable of presenting to the viewer an assemblage of related promotional content, and dynamically selecting the specific set of content elements, triggered in part by a viewer's characteristics.

Embodiments of the invention further involve a computer implemented system that tracks the activity of the users across the various content, engagement, transactional and sharing activities that are offered, and records the activity of each element, while maintaining a record of the context of the overall set in which it was presented to a viewer.

Embodiments of the invention further involve a data analysis system capable of assessing the quality and effectiveness of specific activities offer in a promotion, or certain sets of activities, based on the recorded patterns of viewer/consumer use and responses.

Embodiments of the invention further involve a computer implemented system capable of maintaining a database of users who have been identified as having greater “influence” in specific domains, and tracking the degree of their interest and receptiveness to specific promotions and to specific elements presented to the viewer as a set.

Embodiments of the invention further involves a data system capable of measuring the “response-impact” that results when a viewer shares the promotion with their social network friends. The response-impact is a measure that combines:
a) Response effectiveness: how effective do invites to friends create new viewers of the promotion, with
b) Engagement extent: the number and type of activities taken by those who respond to the invites.

Embodiments of the invention further involve a computer implemented system capable of calculating and assigning certain “performance factors” to aggregate statistics and thereby characterizing, at a high level, the comparative performance of specific business promotions or of consumer-specific variants of a single major promotion.

Embodiments of the invention further involve a technology system capable of using the prior use history of an individual user in a manner that provides a sequential experience for the user. This can be a simple sequence or a logical branching based on the user's specific prior action. For example, assume a user undertakes a specific action, then upon a return visit, even if separated by significant passage of time, a subsequent presentation of the display can represent an acknowledgement of the prior action (e.g. “thank you for your recent buy”), a logical follow-up to the prior action (e.g. “you tried level 1, now take a look at level 2”), or a consequence of that category of actions (e.g. “we have almost reached our goal”). This sequential experience capability shapes the presentation specifically to a repeat user, heightens the engagement for that user, and can increase the likelihood of influential sharing.

Some aspects of the technology for tracking and determining influence have been described in, for example, U.S. application Ser. No. 12/288,614 filed on Oct. 21, 2008 and U.S. application Ser. No. 12/460,223 filed on Jul. 14, 2009, which are both incorporated by reference to this patent application in their entirety.

Further details of embodiments of the invention are described in Appendix A (6 pages) by the inventors, which is hereby incorporated in its entirety.

1. A method for assessing engagement activities and influence using consumer-specific promotions in a social network environment, comprising:
(a) having a communication network system being a social network communication system with a plurality of social network members, wherein each of said social network members has a personal characteristic, wherein said personal characteristics include demographic information and prior engagement activities related to activities related to sponsored promotions within said social network;
(b) presenting, using a computer system to one of said social network members, a web page having an engagement zone and a sharing zone, wherein said engagement zone presents two or more versions of a promotional item from a sponsoring business each of said presented versions customized according to said personal characteristics, and wherein said sharing zone lists friends of said member in said social network;
(c) selection using said computer system one of said versions of said promotional item from said engagement zone and selecting one or more friends in said sharing zone to then share said selected version with said selected friends; and
(d) having a computer data system for tracking said historic sharing activity of said selected version of said promotional item within said social network among said friends and determining a measure of said sharing activity.
